(19) United States
(12) Patent Application Publication
(10) Pub. No.: US 2004/0198226 A1
(43) Pub. Date: Oct. 7, 2004

(54) Method and system for dynamically managing wireless communications system protocols

(76) Inventors: Michael R. Watson, San Jose, CA (US); Raymond Chock, San Jose, CA (US); Sam Gebala, Anacortes, WA (US); T. Allan Hamilton, San Jose, CA (US)

Correspondence Address: PARSONS HSUE & DE RUNTZ LLP, 655 MONTGOMERY STREET, SUITE 1800, SAN FRANCISCO, CA, 94111, US

(21) Appl. No.: 10/826,785

(22) Filed: Apr. 16, 2004

Related U.S. Application Data
(63) Continuation of application No. 09/207,694, filed on Dec. 8, 1998.

(51) Int. Cl. H04M 11/00

(52) U.S. Cl. 455/41.2; 455/41.3

(57) ABSTRACT

A Method and System for Dynamically Managing Wireless Communications System Protocols is disclosed. Also disclosed is a method and system that automatically detects and enables the most advanced Stack and Application Sets available on a pair of devices in wireless communications with one another. The preferred device includes detector means in wireless communication with the other device or devices for detecting the configuration of the application set of the other device(s). The preferred device further includes selector means for enabling the optimum communication protocol stack responsive to the application set configuration of the other device. Furthermore, the preferred device enables the optimum internal application set responsive to the application set of the other device. Still further, the device commences (and re-establishes broken) communications using a default communication protocol stack and application set.

### BACKGROUND OF THE INVENTION

1. Field of the Invention

This invention relates generally to wireless communications between electronic appliances and, more specifically, to a Method and System for Dynamically Managing Wireless Communications. System Protocols.

2. Description of Related Art

As manufacturing capabilities have improved, electronic appliances have become smaller and smaller, while simultaneously offering more features and capabilities than their predecessors, and furthermore at reduced cost to the consumer. As a result, portable electronic appliances, such as computers, personal digital assistants (PDA's) and cameras have nearly become commonplace for businesses and even for the casual user. The proliferation of these powerful portable devices has led to the desire for the ability to share and otherwise transfer information without the need for a hardwired connection. Wireless communications technology, and particularly Infrared (Ir) and Radio Frequency (RF) communications between portable electronic appliances has evolved quickly to satisfy this demand. In fact, it is virtually impossible to purchase either a PDA or Portable Computer that does not include Ir communications capability.

As the physical implementation of wireless communications has expanded rapidly, this rapid development has also resulted in the nearly uncontrolled release of software to interface with the wireless communications hardware. Moreover, it is fairly common for individuals to purchase a particular Ir-enabled appliance (for example) with a pre-installed Ir Communications Protocol Stack (Stack) and Applications Set (App. Set) that are obsolete. While the obsolete software is functional, it's performance is not optimal. Furthermore, heretodate it has been impossible to upgrade the App Set because the obsolete Stack would not be capable of communicating with it. Also, even if you could upgrade both the Stack and App Set, you would be incapable of “downgrading” the Stack and App Set in the eventuality that the device with which you wish to link still has its default Stack and App Set.

What is needed, therefore, is a system and method internal to the electronic device that will automatically detect and enable the most advanced Stack and App Set available on both devices.

### SUMMARY OF THE INVENTION

In light of the aforementioned problems associated with the prior methods and systems it is an object of the present invention to provide a Method and System for Dynamically Managing Wireless Communications System Protocols. The preferred method and system will automatically detect and enable the most advanced Stack and Application Set available on a pair of devices in wireless communications with one another. It is an object to provide a device having detector means in wireless communication with another device or devices for detecting the configuration of the application set of the other device(s). The preferred device will further include selector means for enabling the optimum communication protocol stack responsive to the application set configuration of the other device. The preferred device will further enable the optimum internal application set responsive to the application set of the other device. It is a further object that the device begin (and re-establish broken) communications using a default communication protocol stack and application set.

### BRIEF DESCRIPTION OF DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a front view of a simulation of a portable computer and a printer engaged in infrared communications;

FIG. 2 is a depiction of the interaction of the Stack and Applications Set in a pair of conventional Ir-enabled appliances having similar software versions;

FIG. 3 is a depiction of the ramification when two Ir-enabled appliances have dissimilar software versions;

FIG. 4 is the method of the present invention for optimizing the Stack and Application Set of an electronic appliance having wireless communications capability; and

FIGS. 5A, 5B and 5C depict the elements of the system of the present invention.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Method and System for Dynamically Managing Wireless Communications System Protocols.

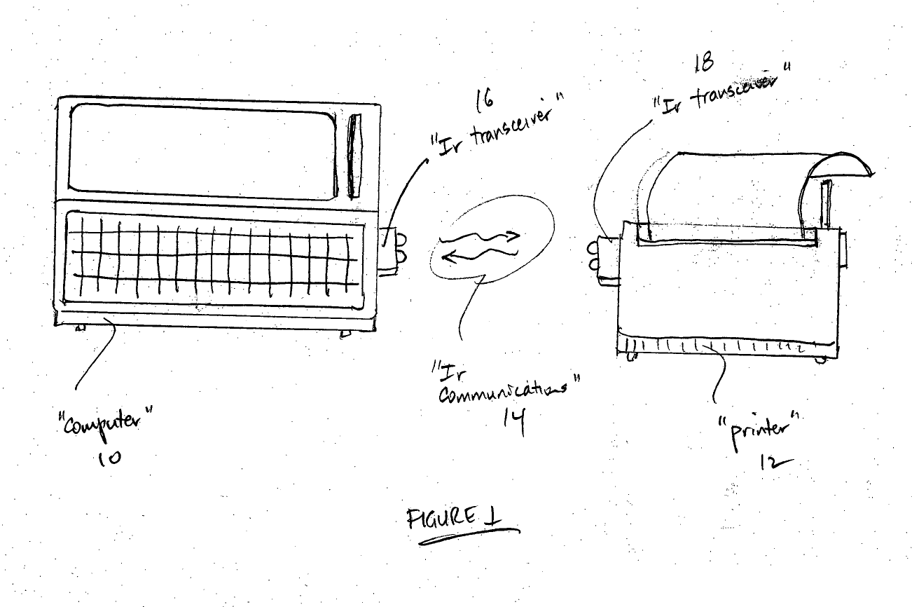

The present invention can best be understood by initial consideration of FIG. 1. FIG. 1 is a front view of a simulation of a portable computer 10 and a printer 12 engaged in infrared communications 14. It should be understood that the present invention also relates to RF and other types of short-range wireless communications system; Ir will be used in the following discussion for the sake of simplicity. It should also be understood that the computer 10 and printer 12 are only exemplary—they represent any of a variety of Ir-enabled electronic appliances. In this example, the portable computer 10 and the printer 12 each include an Ir transceiver 16 and 18, respectively, to enable the infrared communications 14 between the pair of devices.

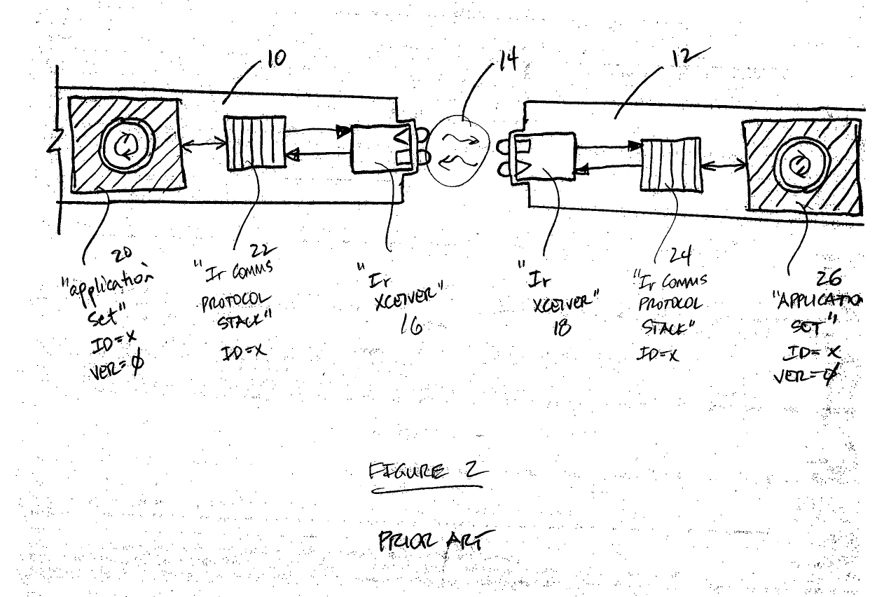

Now turning to FIG. 2, we will delve deeper into the operations of a conventional Ir-enabled appliance. FIG. 2 is a depiction of the interaction of the Ir communications-related software packages in the computer 10 and printer 12 of FIG. 1. In order for the computer 10 to execute a simple print function via the Ir transceiver 16, the (print) application set 20 must communicate with the Ir transceiver 16 through the Ir communications protocol stack 22. The Ir communications stack 22 is essentially a set of instructions located in resident memory, that coordinate or translate instructions emanating from, and coming into, the application set 20. The application set 20 is one or more software programs residing in permanent and/or resident memory within the computer 10, in this case for commanding and receiving responses from the printer 12.

Similarly, the printer 12 has its own Ir stack 24 and app set 26. In this depiction, the computer's app set 20 has a certain identification and version; ID=X, Ver=0 for example. The stack 22 has its own version or revision; ID=X, for example. As shown, the printer 12 has an app set 26 having ID=X, Ver=0 and a stack 24 with ID=X—since the stacks 22 and 24 and app sets 20 and 26 are of like versions and identifications, the app sets 20 and 26 can interface to permit Ir communications 14.

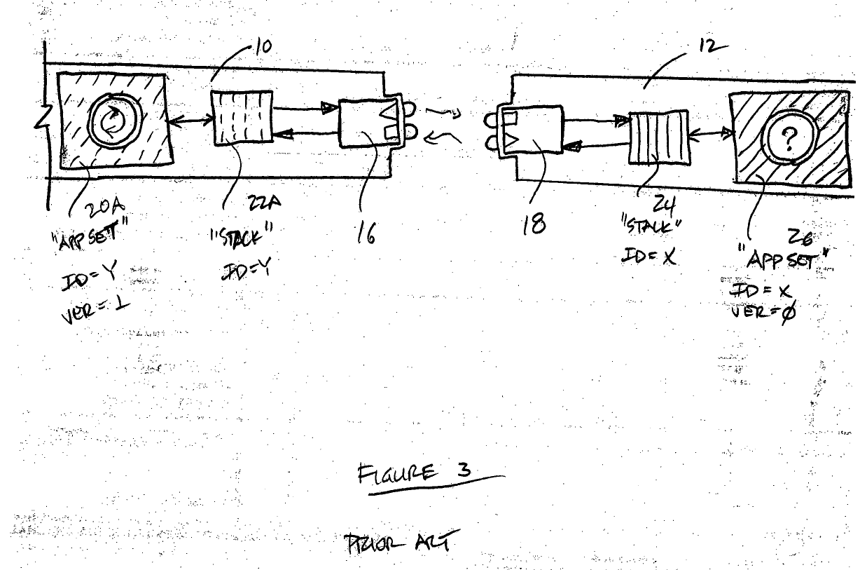

Now turning to FIG. 3, we will analyze the effect of disparities between app sets and/or stacks. In FIG. 3, the computer 10 has installed within it an ID=Y stack 22A and a Y/1 app set 20A. Let us assume that these software packages have been upgraded to more recent versions by the user because additional functionality was desired. Unfortunately, the printer 12 has not been upgraded, and the stack 24 and app set 26 are the default ID's and versions. Now, when Ir communications 14 are attempted between the two (such as if the computer 10 was sending a print command to the printer 12), the printer app set 26 is unable to respond correctly to the issued command. The results are unpredictable—the printer may print normally, or it might print garbled data, or it might simply do nothing. Furthermore, in another situation, the computer 10 might be the device with the default app set and stack, and the printer 12 the device with upgraded software—the result would very possibly be the same.

The reader should note that we discuss the Ir communications 14 as such in the interest of simplicity—it should be understood that Ir communications 14 may be possible between a certain pair if appliances even if the app sets do not match. However, since the app sets may not “understand” one another, some or all of the desired functionality might be lost or may produce erroneous operations.

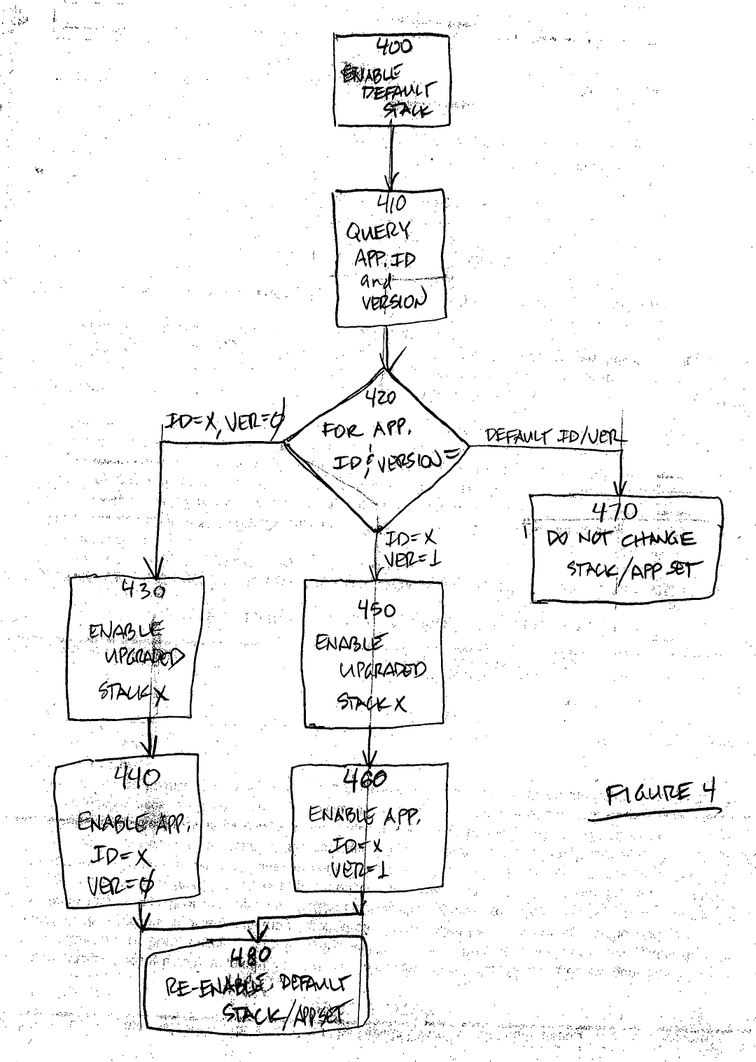

We shall now turn to FIG. 4 to discuss the operation of the present invention. FIG. 4 is a block diagram of a preferred method of the present invention for optimizing the Stack and Application Set of an electronic appliance having wireless communications capability. This method is resident within a particular appliance for internally optimizing the app set and stack.

Step 400 indicates that the device will first begin with the default stack being enabled. Upon establishment of communications with another device, the instant device will execute step 410 and query the peripheral device for the ID and/or version of its pertinent application(s) (i.e. the print application(s)). Next, step 420 will branch according to the returned application(s) ID and/or version—those branches shown are for example only.

Let's assume that the peripheral device returns the values ID=X, Ver=0 for its app set. In response, the instant device will execute step 430 and enable stack ID=X; Next, step 440 will be executed to enable application set ID=X, Ver=0.

Should the peripheral device return app set values ID=X, Ver=1 for its app set, the instant device will execute step 450 and enable stack ID=X. Next, step 460 will be executed to enable application set ID=X, Ver=1. Obviously, the instant device must have the aforementioned app set and stack versions available in (typically permanent) memory in order to make steps 430, 440, 450 and 460 possible. After completion of steps 440 and 460, the instant device will execute step 480, thereby re-enabling the default stack and app set.

If the peripheral device returns a default ID/version, the instant device will execute step 470, and refrain from changing the stack and/or app set in use. These steps are provided as the barest outline of the steps involved in optimizing the stack and app set in the instant device. While the method is accurate in portraying the pertinent steps involved in the optimization process, it should be realized that other steps might also be executed. Furthermore, the instant device might have a plurality of ID's and versions of app sets and stacks; in such situations, one branch will exist for each unique app set/stack combination.

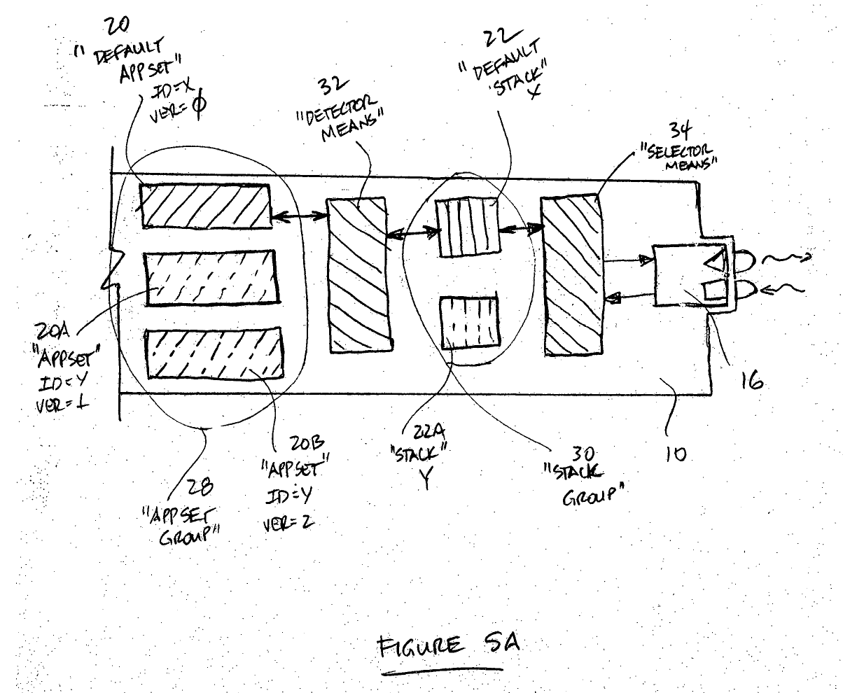

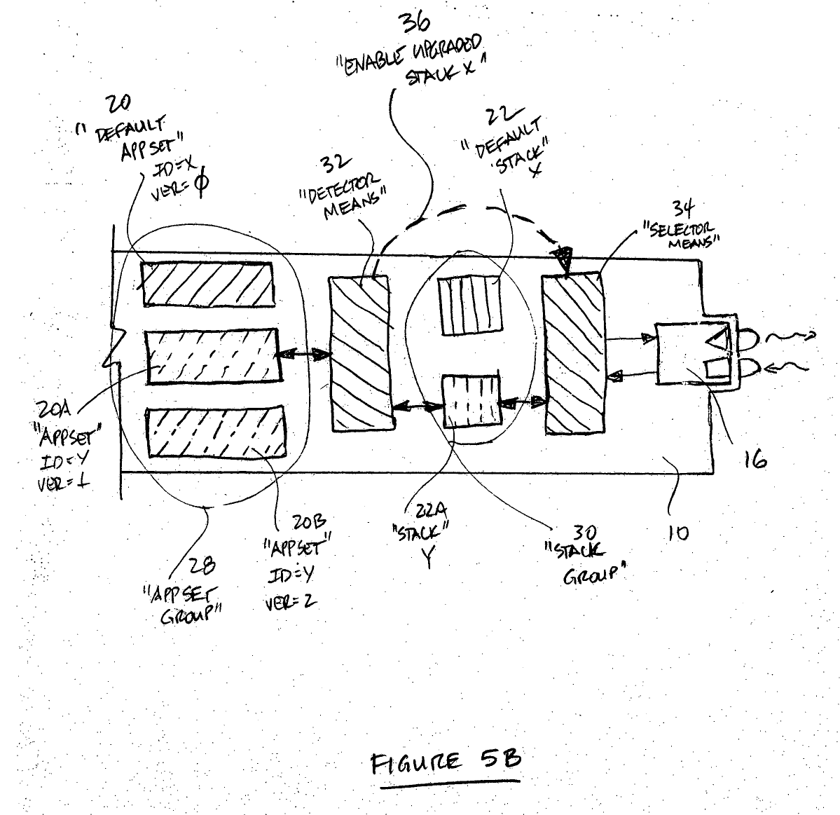

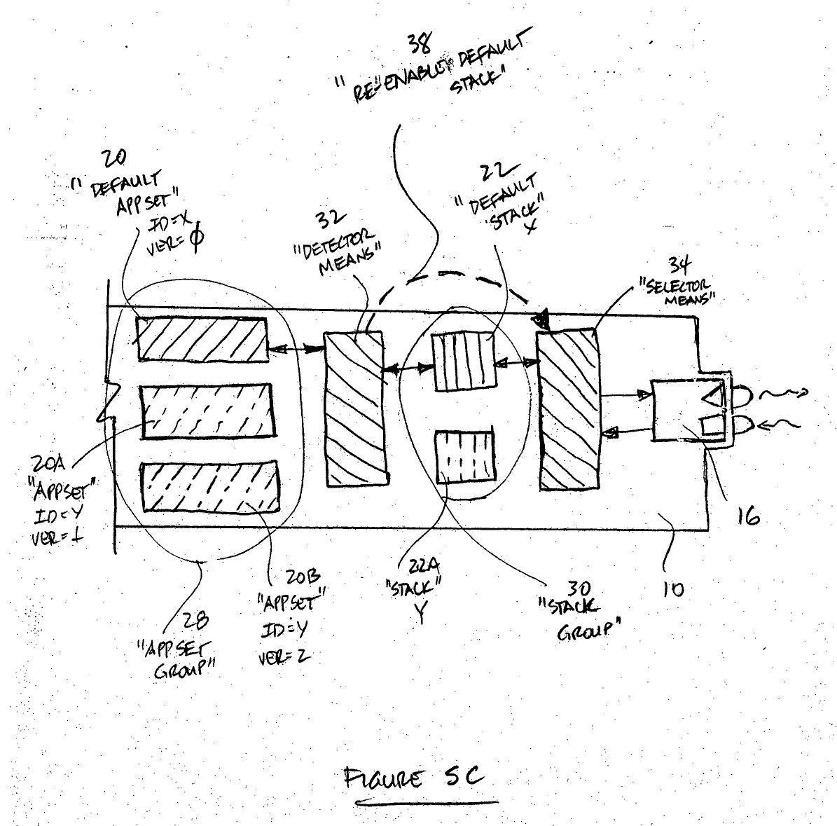

Review of FIGS. 5A-5C will give further insight into the operation of the system of the present invention. As can be seen, the preferred Ir-enabled device 11 (such as the computer 10 of FIGS. 1-3) has a default application set 20. However, in this embodiment, app set 20A having ID=Y and Ver=1, as well as app set 20B with ID=Y and Ver=2 are resident and available within the device 11. The app sets 20A, B and C make up an app set group 28. Also, in addition to the default stack 22, a stack ID=Y is also available, the two stacks making up the stack group 30.

In communication with the app set group 28 and the stack group 30 is a detector means 32 for monitoring and detecting the composition of the app set group 28, the stack group 30, and the app set of the peripheral (or other) device (once Ir “discovery” occurs). The detector means 32 also has the function of enabling or disabling the appropriate app set. In communication with the detector means 32 is a selector means 34 for enabling and disabling the appropriate stack in response to command from the detector means 32. In FIG. 5A, the app set group 28 and stack group 30 are in default conditions, such as immediately preceding Ir communications. The detector means 32 and selector means 34 will preferably comprise software running in resident memory.

FIG. 5B depicts the device response when the peripheral device returns app set Y/1 (and stack Y). Upon realization by the detector means 32 of the situation, it will send a signal 36 to the selector means 34 to “enable upgraded stack Y”, while the detector means enables app set 20A Y/1. As shown in FIG. 5C, once the conversion is completed, operations through the stack 22A and app set 20A can proceed; as discussed earlier in connection with FIG. 4, and the detector means will re-enable the default app set 20 and also send a signal 38 to the selector means 34 to re-enable the default stack set 22.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

1. A system for internally optimizing wireless communications between a pair of devices, each said device comprising an application set group comprising at least one application set and a stack group comprising at least one stack, said application set group and said stack group in communication with a wireless transceiver, comprising:
a first said device comprising:
a detector in communication with said application set group for detecting the configuration of said application set in a second said device; and
a stack selector for enabling the optimum said stack responsive to said detecting.

2. The system of claim 1, wherein said detector further enables the optimum
said application set responsive to said detecting.

3. The system of claim 2, wherein an initial communications condition is defined, said initial communications condition comprising said detector enabling a default said application set and said stack selector enabling a default said stack.

4. The system of claim 3, wherein said initial communications condition is reestablished upon cessation of said wireless communications.

5. A method of internally optimizing communications between a pair of devices, each said device comprising an application set group comprising at least one application set and a stack group comprising at least one stack, said application set group and said stack group in communication with a wireless transceiver, comprising the steps of:
default enabling, wherein a stack selector in communication with said stack group for selecting the optimum said stack enables a default said stack; and
upgrade enabling, wherein said stack selector enables an upgraded said stack.

6. The method of claim 5, further comprising the step of:
querying, wherein a detector for detecting the configuration of said application set group in another said device queries said other device for the configuration of its said application set group.

7. The method of claim 6, wherein said upgrade enabling further comprises said detector enabling the optimum said application set.

8. The method of claim 7, further comprising a re-enabling step after said upgrade step, said re-enabling step comprising said detector enabling a default said application set.

9. The method of claim 8, wherein said re-enabling step further comprises said stack selector enabling said default stack.

10-13. (Cancelled)

14. A system for internally optimizing wireless communications between a pair of devices, each said device comprising an wireless transceiver, an application set group comprising at least one application set and a stack group comprising at least one stack, said application set group in communication with said stack group and said stack group in communication with said wireless transceiver, comprising:
a first said device comprising:
an application set detector in communication with said application set group for detecting the configuration of said application set in a second said device; and
a stack and application set selector for enabling the optimum said stack responsive to said second device application set as detected by said first device application set detector.

15. The system of claim 14, wherein said application set detector further enables the optimum said application set responsive to said second device application set as detected by said first device application set detector.

16. The system of claim 15, wherein an initial communications condition is defined, said initial communications condition comprising said application set detector enabling a default said application set and said stack and application set selector enabling a default said stack.

17. The system of claim 16, wherein said initial communications condition is re-established upon cessation of said wireless communications.
